(19) United States
(12) Patent Application Publication
(10) Pub. No.: US 2023/0365026 A1
(43) Pub. Date: Nov. 16, 2023

(54) FUEL CELL THERMAL MANAGEMENT CONTROL SYSTEMS AND METHODS

(71) Applicant: Nikola Corporation, Phoenix, AZ (US)

(72) Inventors: Brandon Christopher Dunn, Gilbert, AZ (US); Erik Virgil Lindstrom, Queen Creek, AZ (US); Akshit Markan, Tempe, AZ (US); Aris Papadopoulos, Mesa, AZ (US); Rahul Shetty, Chandler, AZ (US)

(21) Appl. No.: 18/322,283

(22) Filed: May 23, 2023

Related U.S. Application Data
(63) Continuation-in-part of application No. 17/938,741, filed on Oct. 7, 2022.
(60) Provisional application No. 63/364,659, filed on May 13, 2022.

(51) Int. Cl. B60L 58/32; H01M 8/0432; H01M 8/04701; B60L 50/72

(52) U.S. Cl. CPC B60L 58/32; H01M 8/04358; H01M 8/04738; B60L 50/72; H01M 2250/20; H01M 2008/1095

(57) ABSTRACT

The present disclosure provides a method of managing thermal loads in a fuel cell electric vehicle. The method may include measuring a coolant temperature at an outlet of a fuel cell radiator, calculating a fuel cell coolant flow value, calculating a fuel cell heat generation value, calculating a feedback portion of a fuel cell radiator fan speed command using the coolant temperature at the outlet of the fuel cell radiator, calculating a feedforward portion of the fuel cell radiator fan speed command using an ambient temperature, the fuel cell coolant flow value, and the fuel cell heat generation value calculating the fuel cell radiator fan speed command using the feedforward portion and the feedback portion, and controlling a fuel cell radiator fan speed using the fuel cell radiator fan speed command.

### CROSS-REFERENCE TO RELATED APPLICATIONS

This application is a continuation-in-part of co-pending U.S. patent application Ser. No. 17/938,741, filed Oct. 7, 2022, entitled “INTEGRATED THERMAL MANAGEMENT SYSTEM.” U.S. patent application Ser. No. 17/938,741 claims priority to, and the benefit of, U.S. Provisional Patent Application Ser. No. 63/364,659 filed on May 13, 2022, entitled “INTEGRATED THERMAL MANAGEMENT SYSTEM.” The disclosures of each of the foregoing applications are incorporated herein by reference in their entireties, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates to thermal management systems, and more particularly, to thermal management systems for fuel cell vehicles.

### BACKGROUND

Fuel cell electric vehicles (FCEVs) utilize multiple fuel cells, combined in one or more fuel cell stacks, to generate an electric current to power one or more system components to operate the vehicle. For example, electric current generated by the fuel cell stack may be used to power one or more electric motors to drive the vehicle's wheels as well as power multiple other electrically operated systems of the vehicle. The electrochemical processes used by the fuel cell stack to generate this current may generate large amounts of heat that may desirably be disposed to prevent adverse impact on fuel cell and vehicle lifespan and performance. In addition, heat generated during regenerative braking may need to be disposed through one or more brake resistors. Approaches which utilize these sources of waste heat in alternative ways to increase system thermal efficiency and increase vehicle lifespan and performance are desirable.

### SUMMARY

In an exemplary embodiment, a method of managing thermal loads in a fuel cell electric vehicle comprises: measuring a coolant temperature at an outlet of a fuel cell radiator; calculating, by a microprocessor onboard the fuel cell electric vehicle, a fuel cell coolant flow value; calculating, by the microprocessor, a fuel cell heat generation value; calculating, by the microprocessor, a feedback portion of a fuel cell radiator fan speed command using the coolant temperature at the outlet of the fuel cell radiator; calculating, by the microprocessor, a feedforward portion of the fuel cell radiator fan speed command using an ambient temperature, the fuel cell coolant flow value, and the fuel cell heat generation value; calculating, by the microprocessor, the fuel cell radiator fan speed command using the feedforward portion and the feedback portion; and controlling a fuel cell radiator fan speed using the fuel cell radiator fan speed command.

In another exemplary embodiment, a method of managing thermal loads in a fuel cell electric vehicle comprises: calculating a fuel cell radiator fan speed command using a first coolant temperature; calculating a brake resistor power command using a second coolant temperature; calculating a brake resistor radiator fan speed command using a third coolant temperature; controlling a fuel cell radiator fan speed using the fuel cell radiator fan speed command; controlling a brake resistor power using the brake resistor power command; and controlling a brake resistor radiator fan speed using the brake resistor radiator fan speed command.

In another exemplary embodiment, a method of managing thermal loads in a fuel cell electric vehicle comprises: measuring a first coolant temperature at an outlet of a brake resistor; calculating a first difference between a brake resistor outlet coolant temperature setpoint and the first coolant temperature; calculating a brake resistor power command using the first difference; measuring a second coolant temperature at an inlet of a pump; calculating a second difference between a pump inlet temperature setpoint and the second coolant temperature; calculating a brake resistor radiator fan speed command using the second difference; controlling a brake resistor power using the brake resistor power command; and controlling a brake resistor radiator fan speed using the brake resistor radiator fan speed command.

The contents of this section are intended as a simplified introduction to the disclosure and are not intended to limit the scope of any claim. The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The accompanying drawings are included to provide a further understanding of the present disclosure and are incorporated in, and constitute a part of, this specification, illustrate various embodiments, and together with the description, serve to explain exemplary principles of the disclosure.

FIG. 1 illustrates a perspective view of an FCEV comprising an integrated thermal management system, in accordance with various embodiments;

FIG. 2 illustrates an integrated thermal management system, in accordance with various embodiments;

FIG. 3 illustrates a flow chart of a method for managing fuel cell thermal loads, and more particularly, for calculating a fuel cell coolant flow value and a fuel cell heat generation value, in accordance with various embodiments;

FIG. 4 illustrates a block diagram of a control logic for implementing the method of FIG. 3, in accordance with various embodiments;

FIG. 5 illustrates a flow chart of a method for managing fuel cell thermal loads, and more particularly, for fuel cell radiator fan speed control, in accordance with various embodiments;

FIG. 6 illustrates a block diagram of a control logic for implementing the method of FIG. 5, in accordance with various embodiments;

FIG. 7 illustrates a flow chart of a method for managing fuel cell thermal loads, and more particularly, for brake resistor power control, in accordance with various embodiments;

FIG. 8 illustrates a block diagram of a control logic for implementing the method of FIG. 7, in accordance with various embodiments;

FIG. 9 illustrates a flow chart of a method for managing fuel cell thermal loads, and more particularly, for brake resistor radiator fan speed control, in accordance with various embodiments; and

FIG. 10 illustrates a block diagram of a control logic for implementing the method of FIG. 9, in accordance with various embodiments.

### DETAILED DESCRIPTION

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical chemical, electrical, and mechanical changes may be made without departing from the spirit and scope of the disclosure. Thus, the detailed description herein is presented for purposes of illustration only and not of limitation.

For example, the steps recited in any of the method or process descriptions may be executed in any suitable order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Additionally, any reference to without contact (or similar phrases) may also include reduced contact or minimal contact.

For example, in the context of the present disclosure, systems, methods, and articles may find particular use in connection with FCEVs, battery electric vehicles (including hybrid electric vehicles), compressed natural gas (CNG) vehicles, hythane (mix of hydrogen and natural gas) vehicles, and/or the like. However, various aspects of the disclosed embodiments may be adapted for performance in a variety of other systems. Further, in the context of the present disclosure, methods, systems, and articles may find particular use in any system requiring use of a fuel cell, brake resistor, and thermal management system of the same. As such, numerous applications of the present disclosure may be realized.

The following nomenclature in Table 1, Table 2, and Table 3 corresponds to measured parameters, controlled parameters, and selected parameters, respectively, described in the present disclosure:

TABLE 1
Sensor Measurements

| Measurement Sensor | Description |
|---|---|
| T_{amb} | Ambient temperature (degrees Celsius—° C.) |
| T_{rad, out} | Coolant temperature at outlet of fuel cell radiator |
| | (° C.) |
| T_{cc-hex} | Coolant temperature at outlet of CC-HEX (° C.) |
| T_{fc, in} | Coolant temperature at inlet of fuel cell system |
| | (° C.) |
| T_{fc, out} | Coolant temperature at outlet of fuel cell system |
| | (° C.) |
| T_{br, out} | Coolant temperature at outlet of brake resistor |
| | (° C.) |
| T_{pump, in} | Coolant temperature at inlet of brake resistor |
| | coolant loop pump (° C.) |
| Tₕₜᵣ_{_{—}}_{core} | Coolant temperature at outlet of cabin heater core |
| | (° C.) |
| P_{fc, in} | Coolant pressure at inlet of fuel cell system |
| | (kilopascals—kPa) |
| P_{fc, out} | Coolant pressure at outlet of fuel cell system |
| | (kPa) |
| Speedᵥₑₕ | Vehicle speed (kilometers per hour—km/h) |

TABLE 2
Controlled Parameters

| Controlled Parameter | Description |
|---|---|
| N_{fan, fc} | Fuel cell radiator fan speed (revolutions per |
| | minute—RPM) |
| N_{fan, br} | Brake resistor radiator fan speed (RPM) |
| N_{pump, fc} | Fuel cell coolant loop pump speed (RPM) |
| N_{pump, br} | Brake resistor coolant loop pump speed (RPM) |
| V_{pos, 1} | First valve position (percent—%) |
| V_{pos, 2} | Second valve position (%) |
| V_{pos, 3} | Third valve position (%) |
| Power_{br} | Brake resistor power request (kilowatts—kW) |

TABLE 3
Selected/Calculated Parameters

| Selected/Calculated | |
|---|---|
| Parameter | Description |
| V_{coolant} | Fuel cell coolant flow value (liters per |
| | minute—LPM) |
| Vₐᵢᵣ | Fuel cell radiator air flow value (LPM) |
| Q_{fc} | Fuel cell heat generation value (kW) |
| dT_{radiator} | Fuel cell radiator temperature differential |
| | (° C.) |
| T_{setpoint, 1} | Fuel cell radiator outlet coolant temperature |
| | setpoint (° C.) |
| T_{setpoint, 2} | Fuel cell radiator inlet coolant temperature |
| | setpoint (° C.) |
| T_{setpoint, 3} | Brake resistor outlet coolant temperature |
| | setpoint (° C.) |
| T_{setpoint, 4} | Pump inlet coolant temperature setpoint |
| | (° C.) |

Modern electric vehicles utilize various power sources to provide electric current to one or more electric motors configured to drive the vehicle's wheels. Among the types of electric vehicles being researched and developed at a wide scale are FCEVs, particularly for heavy-duty applications. Similar to traditional internal combustion engine vehicles (ICEVs), FCEVs generate large amounts of heat through the operation of various systems. Among the systems that generate heat are the fuel cell system, which generates heat as a result of exothermic chemical reactions taking place in fuel cell catalyst layers, and the braking system, which generates heat due to friction in the case of friction braking systems and resistive heating in the case of regenerative braking systems. Traditionally, heat generated by the fuel cell system and the braking system was disposed of using discrete thermal management systems for the fuel cell and the braking system, respectively. However, integrating these thermal management systems can result in numerous benefits, namely, increased thermal efficiency, reduced part count, and reduced system complexity. Increasing thermal efficiency can result in increased range as less power is required to operate the thermal systems and instead can be used to power the electric motor(s). Reducing part count not only reduces costs but also can help reduce the space occupied by the thermal systems. Finally, reducing thermal system complexity can lead to greater vehicle uptime because the number of potential failure points and the time associated with maintenance and service tasks can be reduced.

While integrating the fuel cell thermal management system with thermal management systems of other systems/components can result in numerous benefits, doing so can present certain challenges. For example, because the fuel cell system relies on the generation of electric potential in order to provide power to the vehicle drivetrain and other power consumers, the introduction of ions into the system can lead to current leakage, short circuiting, and/or reduced power output. One of the ways ions can be introduced to the fuel cell system is through the coolant, which can become increasingly conductive due to leaching, degradation, and corrosion of system materials and formation of organic acids resulting from the degradation of the coolant itself. As a result, these issues are desirably addressed when integrating a fuel cell system into a thermal management system that also manages other vehicle systems/components.

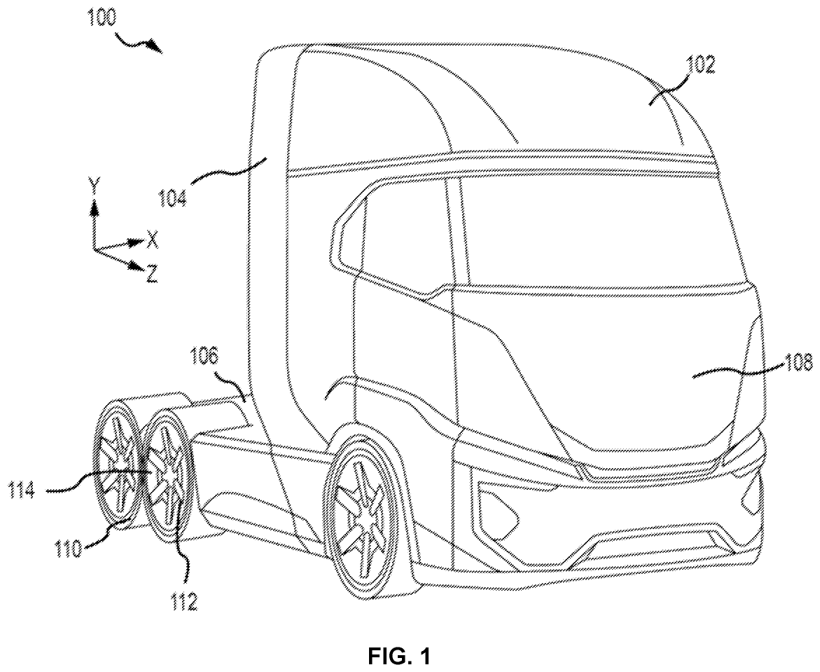

Accordingly, with reference to FIG. 1, a perspective view of a vehicle 100 incorporating an integrated thermal management system is illustrated, in accordance with various embodiments. In various embodiments, vehicle 100 is an electric vehicle incorporating an electric powertrain. More specifically, vehicle 100 may be an electric commercial vehicle, such as, for example, a class 8 heavy-duty commercial vehicle. Vehicle 100 may be an FCEV, a battery electric vehicle (BEV), or any other vehicle comprising an energy source, a braking system, and a cabin utilizing thermal management. Moreover, vehicle 100 may comprise a commercial vehicle of a different weight class or a passenger vehicle in various embodiments. While discussed primarily herein as comprising an electric vehicle with an electric drivetrain, it should be appreciated that vehicle 100 may comprise any vehicle type in need of thermal management, including ICEVs of various sizes and applications.

Vehicle 100 comprises a body 102 which defines a cabin 104 configured to contain at least one passenger. For example, cabin 104 may comprise one or more seats, sleepers, or other features configured to provide comfort to an operator or other passenger. Vehicle 100 comprises a heating, ventilation, and air conditioning (HVAC) system which may provide clean air, heat, and cooling to cabin 104 depending on the ambient temperature where vehicle 100 is operating. While illustrated herein as comprising a cabover style body, body 102 is not limited in this regard and may comprise an American style or other style of body.

Vehicle 100 further comprises a battery system 106. Battery system 106 may be a rechargeable, or secondary, battery configured to store electrical energy from an external power source (for example, a charging station), from a fuel cell stack, from a solar panel disposed on vehicle 100, and/or from regenerative braking or other applications. Battery system 106 may release this stored electrical energy to power one or more electric motors and/or to supply power to other vehicle components requiring electricity to operate. In various embodiments, battery system 106 may be a lithium-ion battery, however, battery system 106 is not limited in this regard and may comprise other rechargeable battery types such as a lead-acid battery, nickel-cadmium battery, nickel-metal hydride battery, lithium iron sulfate battery, lithium iron phosphate battery, lithium sulfur battery, solid state battery, flow battery, or any other type of suitable battery. Battery system 106 may further comprise multiple battery cells coupled in series and/or parallel to increase voltage and/or current. The cells of battery system 106 may comprise any suitable structure including cylindrical cells, prismatic cells, or pouch cells. Moreover, battery system 106 may at least partially comprise other energy storage technologies such as an ultracapacitor.

In various embodiments, in addition to battery system 106, vehicle 100 comprises a fuel cell system 108. Fuel cell system 108 may comprise one or more fuel cells capable of facilitating an electrochemical reaction to produce an electric current. For example, the one or more fuel cells may be proton-exchange membrane (PEM) fuel cells which may receive a fuel source (such as diatomic hydrogen gas) which may react with an oxidizing agent (such as oxygen) to generate electricity with heat and water as byproducts. The fuel cells may be electrically coupled in series and/or parallel to increase voltage and/or current and form one or more fuel cell stacks, which together form fuel cell system 108. In various embodiments, fuel cell system 108 may comprise fuel cells other than PEM fuel cells, for example, alkaline fuel cells, phosphoric acid fuel cells, molten carbonate fuel cells, solid oxide fuel cells, or any other suitable fuel cell type.

Battery system 106 and fuel cell system 108 may be configured to collectively or individually provide power to one or more electric motors in order to drive one or more wheels 110 of vehicle 100. For example, in various embodiments, vehicle 100 comprises an electric axle or eAxle 112 containing one or more electric motors and a gear assembly configured to provide torque to a drive shaft. Electric current may be delivered to the electric motor(s) via battery system 106 and/or fuel cell system 108. For example, in various embodiments, fuel cell system 108 may charge battery system 106 and battery system 106 may provide electric current to eAxle 112. Alternatively, fuel cell system 108 may provide electrical power directly to eAxle 112. In various embodiments, vehicle 100 comprises a 6×2 configuration with a single drive axle and two powered wheel ends, however, is not limited in this regard and may comprise any suitable configuration, for example a 4×2, 6×4, 6×6, or other suitable configuration.

Vehicle 100 further comprises a braking system 114 with a brake assembly coupled to one or more of the wheel ends of vehicle 100. In various embodiments, braking system 114 comprises a regenerative braking system, a friction braking system, or a combination thereof. As vehicle 100 decelerates, the electric motor(s) in eAxle 112 may act as generators and convert kinetic energy to electrical energy to charge or recharge battery system 106. When battery system 106 is fully charged or unable to accept the amount of power generated by the regenerative braking system, some of the electrical energy may be dissipated as heat in one or more brake resistors. Dissipating excess electrical energy as heat may help prevent damage to certain system components (such as the electric motor) in response to large power spikes. Without thermal management, the brake resistors can overheat, and the vehicle must instead rely on the use of the friction braking system in order to slow the vehicle. Accordingly, thermal management of braking system 114 (and brake resistors therein) is desirable.

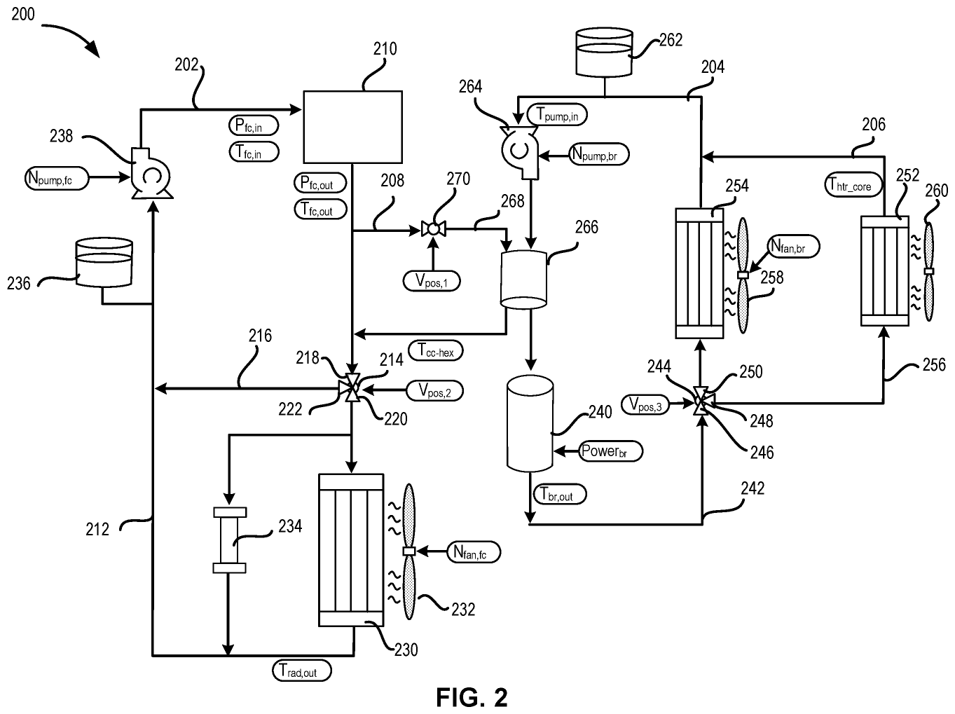

With reference to FIG. 2, an integrated thermal management system 200 of vehicle 100 is illustrated, in accordance with various embodiments. In various embodiments, integrated thermal management system 200 comprises a fuel cell coolant loop 202, a brake resistor coolant loop 204, an HVAC coolant loop 206, and a heat exchanger loop 208. Fuel cell coolant loop 202, brake resistor coolant loop 204, HVAC coolant loop 206, and heat exchanger loop 208 may be thermally and fluidly coupled together to form integrated thermal management system 200. In general, integrated thermal management system 200 may be capable of: cooling a fuel cell system of fuel cell coolant loop 202, heating the fuel cell system of fuel cell coolant loop 202, cooling a brake resistor of brake resistor coolant loop 204, and heating a cabin of the vehicle through HVAC coolant loop 206. While discussed herein as comprising a fuel cell coolant loop 202, a brake resistor coolant loop 204, and an HVAC coolant loop 206, it should be appreciated more or fewer coolant loops may be included in integrated thermal management system 200 (for example, a powertrain coolant loop, a battery coolant loop, and/or an electronics coolant loop). Moreover, in various embodiments, integrated thermal management system 200 may also comprise one or more refrigeration loops, such as one or more vapor-compression refrigeration loops configured to provide additional cooling capacity to the systems or components of vehicle 100. Additionally, while labeled “fuel cell coolant loop,” it should be appreciated that fuel cell coolant loop 202 could be configured to thermally manage any heat generating, power delivering system with or without a fuel cell system (such as a battery system or internal combustion engine). Moreover, while labeled “brake resistor coolant loop,” it should be appreciated that brake resistor coolant loop 204 could be configured to thermally manage any heat generating braking system or component with or without a brake resistor (such as a friction braking system).

In various embodiments, integrated thermal management system 200 includes one or more controllers (e.g., processors) and one or more tangible, non-transitory memories capable of implementing digital or programmable logic. In various embodiments, for example, the one or more controllers comprise one or more of a general-purpose processor, digital signal processor (DSP), application specific integrated circuit (ASIC), field programmable gate array (FPGA), or other programmable logic device, discrete gate, transistor logic, integrated circuit, or discrete hardware components, or any various combinations thereof or the like.

Fuel cell coolant loop 202 is configured to provide heat to or remove heat from a fuel cell system 210 (which may be the same as fuel cell system 108 described in relation to FIG. 1) depending on ambient temperatures and operating conditions. For example, in various embodiments, fuel cell system 210 is thermally and fluidly coupled to the other components of fuel cell coolant loop 202 via a fuel cell coolant line 212. Fuel cell coolant line 212 may be configured to contain a first coolant configured to absorb and transfer heat. In various embodiments, the first coolant in fuel cell coolant loop 202 comprises a chemically inert fluid having a high thermal capacity and a relatively low viscosity. The first coolant may comprise a gaseous fluid such as air, helium, or other inert gas, or may comprise a liquid fluid such as water, ethylene glycol, propylene glycol, betaine, polyalkylene glycol, or other suitable coolant. As discussed above, too much conductivity in the first coolant for fuel cell system 210 may adversely impact fuel cell performance and/or longevity, so deionized coolant such as water or water/glycol mixture may be desirable. Moreover, increased coolant conductivity could decrease the isolation resistance of the vehicle, thereby creating a safety hazard for persons interacting with the vehicle such as operators, service technicians, and/or first responders. In various embodiments, the first coolant of fuel cell coolant loop 202 comprises additives such as non-ionic corrosion inhibitors and/or ion-suppressing compounds such as ion-exchange nanoparticles. The first coolant of fuel cell coolant loop 202 may comprise a conductivity of less than 10 μS/cm, a conductivity of less than 5 μS/cm, or a conductivity of less than 2 μS/cm in various embodiments.

Fuel cell coolant loop 202 further comprises a first valve 214. First valve 214 is downstream of and thermally and fluidly coupled to fuel cell system 210 via fuel cell coolant line 212. In various embodiments, first valve 214 comprises a diverting valve such as a three-way valve, for example. Stated otherwise, first valve 214 may comprise three openings, including one inlet and two outlets. First valve 214 is configured to receive the first coolant from fuel cell system 210 through inlet 218 and, depending on an operating mode, deliver the first coolant through first outlet 220 (to a fuel cell radiator as will be discussed in further detail below), deliver the first coolant through second outlet 222 (to bypass the fuel cell radiator as will be discussed in further detail below), or deliver a portion of the first coolant through first outlet 220 and deliver a portion of the first coolant through second outlet 222. In various embodiments, first valve 214 may be configured with multiple positions to adjust the amount of the first coolant that is directed through first outlet 220 and second outlet 222, respectively. In various embodiments, first valve 214 is configured with 90 discrete positions, however, first valve 214 is not limited in this regard and may comprise a valve configured with more or fewer positions.

Fuel cell coolant loop 202 further comprises a fuel cell radiator 230 downstream of and thermally and fluidly coupled to first valve 214 via fuel cell coolant line 212. Fuel cell coolant loop 202 may further comprise one or more T connectors or Y connectors downstream of first valve 214 and upstream of fuel cell radiator 230. Depending on an operating mode, the first coolant may be configured to flow through first outlet 220 of first valve 214, into an inlet of fuel cell radiator 230, and out of an outlet of fuel cell radiator 230. Fuel cell radiator 230 may be configured to transfer heat stored in the first coolant (resulting from the transfer of heat from fuel cell system 210 to the first coolant, for example) to an external environment (for example, the ambient environment external to vehicle 100). While illustrated as comprising a single radiator, fuel cell radiator 230 is not limited in this regard and may comprise two or more radiators coupled in series and/or parallel. Fuel cell radiator 230 may comprise internal, serpentine tubing configured to contain and route the first coolant and one or more fins (or similar structures) that are configured to increase surface area. As heated coolant flows through the tubing of fuel cell radiator 230, heat may be transferred to the external environment via (or primarily via) convective heat transfer. As a result, the first coolant may be cooled as it flows through fuel cell radiator 230. In various embodiments, fuel cell radiator 230 is equipped with a fan 232, which may assist in convective heat transfer to the external environment. However, in various embodiments, fuel cell radiator 230 is devoid of a fan and instead utilizes air flowing into and/or around vehicle 100 to assist in heat transfer, which may reduce power consumption resulting from operation of the fan.

In various embodiments, fuel cell coolant loop 202 further comprises an ion exchanger 234 downstream of and thermally and fluidly coupled to first valve 214 via fuel cell coolant line 212. Depending on the operating mode, the first coolant may be configured to flow through first outlet 220 of first valve 214, into an inlet of ion exchanger 234, and out of an outlet of ion exchanger 234. Ion exchanger 234 may be configured to reduce the conductivity of the first coolant as the first coolant passes through ion exchanger 234. In various embodiments, ion exchanger 234 comprises a cartridge housing comprising a resin having a mixed bed of negatively charged anions and positively charged cations. The mixed bed may be configured with any suitable anion/cation ratio, for example, 1:1, 2:1, 1:2, or other desired ratio. As the first coolant travels through ion exchanger 234, anions in the first coolant may react with cations in ion exchanger 234 and cations in the first coolant may react with anions in ion exchanger 234. As a result, the conductivity of the first coolant may be reduced. The first coolant flowing through ion exchanger 234 may be reintroduced to fuel cell coolant line 212 downstream of ion exchanger 234, for example via a T connector or Y connector.

In various embodiments, fuel cell coolant loop 202 comprises a T connector or Y connector upstream of fuel cell radiator 230 and ion exchanger 234. The T connector or Y connector may permit the first coolant coming from first valve 214 to be split into two flow paths, with a first flow path being configured to flow through fuel cell radiator 230 and a second flow path being configured to flow through ion exchanger 234. As a result, at least a portion of the first coolant may continually be deionized by being passed through ion exchanger 234. The two flow paths may recombine downstream of fuel cell radiator 230 and ion exchanger 234 through the use of another T connector or Y connector.

Alternatively, fuel cell coolant loop 202 may be configured such that, depending on an operating mode, all of the first coolant is passed through fuel cell radiator 230 or all of the first coolant is passed through ion exchanger 234. For example, in various embodiments, the T connector or Y connector upstream of fuel cell radiator 230 and ion exchanger 234 may be replaced with a valve configured to permit or prevent flow to fuel cell radiator 230 or ion exchanger 234. Fuel cell coolant loop 202 may default to passing the first coolant through fuel cell radiator 230 rather than ion exchanger 234. For example, in various embodiments, the valve may be configured such that a first outlet (to fuel cell radiator 230) is normally open and a second outlet (to ion exchanger 234) is normally closed. As a result, absent some signal (for example, a controller area network (CAN) signal) indicating an instruction to pass the first coolant through ion exchanger 234, the first coolant is passed through fuel cell radiator 230 instead of ion exchanger 234. In various embodiments, integrated thermal management system 200 may be configured such that the first coolant is passed through ion exchanger 234 at predetermined time increments (for example, at vehicle startup or shutdown, once a minute, once an hour, once a day, and so on) or in response to a measured conductivity of the first coolant exceeding a threshold value (for example, >2 μS/cm, >5 μS/cm, >10 μS/cm). In various embodiments, fuel cell coolant loop 202 further comprises a conductivity sensor that may be placed in any suitable position in fuel cell coolant loop 202, such as on an expansion tank, downstream of fuel cell system 210, downstream of first valve 214, or upstream and/or downstream of ion exchanger 234. Moreover, while illustrated being thermally and fluidly connected in parallel, fuel cell coolant loop 202 is not limited in this regard and fuel cell radiator 230 and ion exchanger 234 may be thermally and fluidly coupled in series with ion exchanger 234 immediately upstream or downstream of fuel cell radiator 230 in various embodiments. Coupling fuel cell radiator 230 and ion exchanger 234 in parallel as opposed to series can reduce and/or minimize a pressure drop in fuel cell coolant line 212.

Fuel cell coolant loop 202 further comprises a first expansion tank 236 downstream of and thermally and fluidly coupled to first valve 214, fuel cell radiator 230, and ion exchanger 234. Depending on an operating mode, first expansion tank 236 may be configured to receive the first coolant directly from first valve 214, fuel cell radiator 230, or ion exchanger 234. For operating modes in which fuel cell radiator 230 and ion exchanger 234 are bypassed, the first coolant may be directed out of second outlet 222 of first valve 214. A T connector or Y connector may fluidly couple together a bypass line 216 connected to the second outlet 222 of first valve 214 and fuel cell coolant line 212. First expansion tank 236 may be configured to protect fuel cell coolant loop 202 by removing excess pressure resulting from heated coolant. For example, as the first coolant travels throughout fuel cell coolant loop 202, the first coolant may absorb heat from various systems, including fuel cell system 210, and the temperature of the first coolant may elevate despite heat transfer taking place in fuel cell radiator 230 or other system component. As the first coolant expands with an increase in temperature, first expansion tank 236 may be configured to accommodate the pressure increase to avoid exceeding a threshold pressure limit of fuel cell coolant loop 202 and/or prevent undesired venting of the first coolant. In various embodiments, first expansion tank 236 comprises a compression expansion tank, bladder expansion tank, diaphragm expansion tank, or any other suitable expansion tank type.

In various embodiments, fuel cell coolant loop 202 further comprises a first pump 238 that may be downstream of first expansion tank 236 and upstream of fuel cell system 210. Similar to all other components or systems of fuel cell coolant loop 202, first pump 238 is thermally and fluidly coupled to first expansion tank 236 and fuel cell system 210 via fuel cell coolant line 212. First pump 238 may be configured to circulate the first coolant throughout fuel cell coolant loop 202. First pump 238 may comprise any suitable fluid pump such as a centrifugal pump, diaphragm pump, gear pump, peripheral pump, reciprocating pump, rotary pump, or other suitable pump.

With continued reference to FIG. 2, as discussed above, integrated thermal management system 200 further comprises brake resistor coolant loop 204, which may be configured to manage and/or repurpose heat generated by a brake resistor 240. While discussed herein as being configured to manage heat from brake resistor 240, it should be appreciated that brake resistor coolant loop 204 may be configured to manage heat generated from any braking system or component, such as other brake system electronics or friction brakes, for example. Brake resistor 240 may be thermally and fluidly coupled to every other component/system of brake resistor coolant loop 204 via a brake resistor coolant line 242. Brake resistor coolant line 242 contains a second coolant configured to absorb and transfer heat. In various embodiments, the second coolant in brake resistor coolant loop 204 may be the same as or different from the first coolant in fuel cell coolant loop 202. Using separate coolants in brake resistor coolant loop 204 and fuel cell coolant loop 202 can reduce, minimize, and/or limit the conductivity of the coolant passing through fuel cell system 210 because ions generated by the components of brake resistor coolant loop 204 are isolated from fuel cell coolant loop 202.

In various embodiments, brake resistor 240 is thermally and fluidly coupled to a third valve 244 via brake resistor coolant line 242. Similar to first valve 214, third valve 244 comprises a diverting valve such as a three-way valve. In various embodiments, third valve 244 comprises a single inlet and two outlets. For example, third valve 244 may comprise an inlet 246 configured to receive the second coolant from brake resistor 240, a first outlet 248 configured to deliver the second coolant to a cabin heater core 252 of HVAC coolant loop 206 via an HVAC coolant line 256, and a second outlet 250 configured to deliver the second coolant to a brake resistor radiator 254 via brake resistor coolant line 242. Depending on an operating mode, third valve 244 may be configured to deliver the second coolant only to cabin heater core 252 and prevent the second coolant from flowing to brake resistor radiator 254, may be configured to deliver the second coolant only to brake resistor radiator 254 and prevent the second coolant from flowing to cabin heater core 252, or may be configured to deliver a portion of the second coolant to brake resistor radiator 254 and deliver a portion of the second coolant to cabin heater core 252. In various embodiments, third valve 244 may be configured with multiple positions to adjust the amount of the first coolant that is directed through first outlet 248 and second outlet 250, respectively. In various embodiments, third valve 244 is configured with 90 discrete positions, however, third valve 244 is not limited in this regard and may comprise a valve configured with more or fewer positions.

Brake resistor radiator 254 may be substantially similar to fuel cell radiator 230 in various embodiments. Brake resistor radiator 254 may be configured to transfer heat stored in the second coolant (resulting from the transfer of heat from brake resistor 240 to the second coolant, for example) to the external environment (for example, the ambient environment external to vehicle 100). While illustrated as comprising a single radiator, brake resistor radiator 254 is not limited in this regard and may comprise two or more radiators coupled in series and/or parallel. Brake resistor radiator 254 may comprise internal, serpentine tubing configured to contain and route the second coolant and one or more fins (or similar structures) that are configured to increase surface area. As heated coolant flows through the tubing of brake resistor radiator 254, heat may be transferred to the external environment via (or primarily via) convective heat transfer. As a result, the second coolant may be cooled as it flows through brake resistor radiator 254. In various embodiments, brake resistor radiator 254 is equipped with a fan 258, which may assist in convective heat transfer to the external environment. However, in various embodiments, brake resistor radiator 254 is devoid of a fan and instead utilizes air flowing into and/or around vehicle 100 to assist in heat transfer, which may reduce power consumption resulting from operation of the fan.

In various embodiments, cabin heater core 252 may be substantially similar to fuel cell radiator 230 and brake resistor radiator 254. However, rather than transferring heat to the external environment, cabin heater core 252 may be configured to transfer heat in the second coolant to cabin 104. While illustrated as comprising a single heater core, cabin heater core 252 is not limited in this regard and may comprise two or more heater cores coupled in series and/or parallel. Cabin heater core 252 may comprise internal, serpentine tubing configured to contain and route the second coolant and one or more fins (or similar structures) that are configured to increase surface area. As heated coolant flows through the tubing of cabin heater core 252, heat may be transferred to cabin 104 (or primarily via) convective heat transfer. As a result, the second coolant may be cooled as it flows through cabin heater core 252. In various embodiments, cabin heater core 252 is equipped with a fan 260, which may assist in convective heat transfer to cabin 104. However, in various embodiments, cabin heater core 252 is devoid of a fan and instead utilizes air flowing into and/or around vehicle 100 to assist in heat transfer, which may reduce power consumption resulting from operation of the fan.

HVAC coolant line 256 and brake resistor coolant line 242 are thermally and fluidly coupled together downstream of cabin heater core 252 and brake resistor radiator 254. For example, depending on the operating mode, the second coolant may flow into an inlet of brake resistor radiator 254, out of an outlet of brake resistor radiator 254, and continue to flow through brake resistor coolant line 242. Alternatively, the second coolant may flow into an inlet of cabin heater core 252, out of an outlet of cabin heater core 252, and continue to flow through HVAC coolant line 256. A fluid fitting such as a T connector or Y connector may fluidly couple together brake resistor coolant line 242 and HVAC coolant line 256.

In various embodiments, brake resistor coolant loop 204 further comprises a second expansion tank 262 downstream of and thermally and fluidly coupled to brake resistor radiator 254 and cabin heater core 252. In various embodiments, second expansion tank 262 and first expansion tank 236 may be identical to one another; in other embodiments, second expansion tank 262 and first expansion tank 236 may differ in one or more characteristics (for example, size, shape, volume, and/or the like). Second expansion tank 262 may be configured to protect brake resistor coolant loop 204 and/or HVAC coolant loop 206 by removing excess pressure resulting from heated coolant. For example, as the second coolant travels throughout brake resistor coolant loop 204 and/or HVAC coolant loop 206, the second coolant may absorb heat from various systems, including brake resistor 240, and the temperature of the second coolant may elevate despite heat transfer taking place in brake resistor radiator 254 or cabin heater core 252. As the second coolant expands with an increase in temperature, second expansion tank 262 may be configured to accommodate the pressure increase to avoid exceeding a threshold pressure limit of brake resistor coolant loop 204 or HVAC coolant loop 206 and/or prevent undesired venting of the second coolant. In various embodiments, second expansion tank 262 comprises a compression expansion tank, bladder expansion tank, diaphragm expansion tank, or any other suitable expansion tank type. In various embodiments, brake resistor coolant loop 204 further comprises a second pump 264 downstream of and thermally and fluidly coupled to second expansion tank 262. Second pump 264 and first pump 238 may be identical to one another; in other embodiments, second pump 264 and first pump 238 may differ in one or more characteristics (e.g., power draw, flow rate, type of pump, size, shape, and/or the like). Second pump 264 may be configured to circulate the first coolant throughout brake resistor coolant loop 204 and/or HVAC coolant lop 206. Second pump 264 may comprise any suitable fluid pump such as a centrifugal pump, diaphragm pump, gear pump, peripheral pump, reciprocating pump, rotary pump, or other suitable pump.

As briefly discussed above, integrated thermal management system 200 further comprises a heat exchanger loop 208. In various embodiments, integrated thermal management system 200 comprises a coolant-coolant heat exchanger 266 downstream of and thermally and fluidly coupled to second pump 264 of brake resistor coolant loop 204. Coolant-coolant heat exchanger 266 is further thermally and fluidly coupled to fuel cell coolant loop 202 via a heat exchanger line 268. Coolant-coolant heat exchanger 266 may be configured to exchange heat between the first coolant in fuel cell coolant loop 202 and the second coolant in brake resistor coolant loop 204. For example, depending on the operating mode, heat stored in the first coolant may be transferred to the second coolant as the first coolant and second coolant flow through coolant-coolant heat exchanger 266. Alternatively, depending on the operating mode, heat stored in the second coolant may be transferred to the first coolant as the first coolant and second coolant flow through coolant-coolant heat exchanger 266. As a result, waste heat generated by one system or component (for example, fuel cell system 210 or brake resistor 240) may be repurposed and used to heat another system or component depending on operating conditions. While illustrated herein as comprising a single pump 264, coolant-coolant heat exchanger 266, and brake resistor 240, it should be appreciated that integrated thermal management system 200 is not limited in this regard and may comprise a plurality of pumps, coolant-coolant heat exchangers, and brake resistors in various embodiments. In some exemplary embodiments, integrated thermal management system 200 comprises a pump, coolant-coolant heat exchanger, and brake resistor for each fuel cell stack included in fuel cell system 210. In some exemplary embodiments, integrated thermal management system 200 comprises a pump, coolant-coolant heat exchanger, and brake resistor for each side (driver and passenger) of vehicle 100.

Coolant-coolant heat exchanger 266 may comprise any suitable heat exchanger type. For example, in various embodiments, coolant-coolant heat exchanger 266 comprises a single-phase heat exchanger having any suitable structure. Coolant-coolant heat exchanger 266 may comprise a shell and tube heat exchanger, gasketed plate heat exchanger, welded plate heat exchanger, spiral plate heat exchanger, lamella heat exchanger, plate and fin heat exchanger, tube fin heat exchanger, heat pipe heat exchanger, double pipe heat exchanger, or any other suitable type of heat exchanger. Moreover, coolant-coolant heat exchanger 266 may be configured with any suitable flow arrangement for the first coolant and the second coolant. For example, in various embodiments, coolant-coolant heat exchanger 266 is a cocurrent flow heat exchanger, countercurrent flow heat exchanger, crossflow heat exchanger, or hybrid (cross and counterflow) heat exchanger.

In various embodiments, heat exchanger loop 208 further comprises a second valve 270 downstream of and thermally and fluidly coupled to fuel cell system 210 and upstream of and thermally and fluidly coupled to coolant-coolant heat exchanger 266. While discussed herein as being positioned upstream of coolant-coolant heat exchanger 266, heat exchanger loop 208 is not limited in this regard and second valve 270 may be positioned downstream of coolant-coolant heat exchanger 266 or anywhere on heat exchanger line 268. In various embodiments, second valve 270 is a normally closed or a normally open electronic shutoff valve. In various embodiments, second valve 270 is configured with a set of discrete positions, for example 90 discrete positions, to allow a desired percentage of coolant to flow through coolant-coolant heat exchanger 266. Depending on the operating mode, second valve 270 may be configured to receive the first coolant from fuel cell coolant loop 202 and allow the first coolant to flow to coolant-coolant heat exchanger 266 or may be configured to prevent the first coolant from flowing to coolant-coolant heat exchanger 266. In various embodiments, the position of second valve 270 (as well as the positions of first valve 214, third valve 244, and speeds of various pumps and fans) may be determined based on communication signals (for example, CAN signals) sent by an onboard thermal management module. In various embodiments, fuel cell coolant loop 202 and heat exchanger loop 208 are thermally and fluidly coupled together via one or more T connectors or Y connectors which may fluidly couple together fuel cell coolant line 212 and heat exchanger line 268.

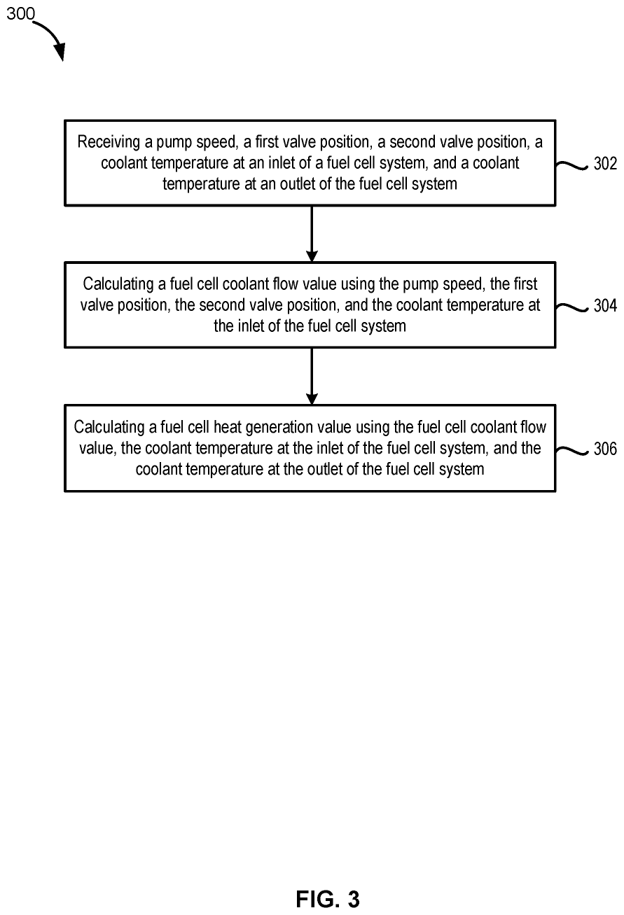

With reference now to FIG. 3, a flow chart illustrating a method 300 of managing thermal loads in an electric vehicle (e.g., an FCEV) is illustrated in accordance with various embodiments. Method 300 may comprise receiving a pump speed, a first valve position, a second valve position, a coolant temperature at an inlet of a fuel cell system, and a coolant temperature at an outlet of the fuel cell system (step 302). Method 300 may further comprise calculating a fuel cell coolant flow value using the pump speed, the first valve position, the second valve position, and the coolant temperature at the inlet of the fuel cell system (step 304). Method 300 may further comprise calculating a fuel cell heat generation value using the fuel cell coolant flow value, the coolant temperature at the inlet of the fuel cell system, and the coolant temperature at the outlet of the fuel cell system (step 306). In various embodiments, method 300 further comprises passing a heated coolant through a fuel cell radiator to cool the fuel cell coolant. In various embodiments, method 300 further comprises controlling/commanding a radiator fan speed using the fuel cell coolant flow value and the fuel cell heat generation value.

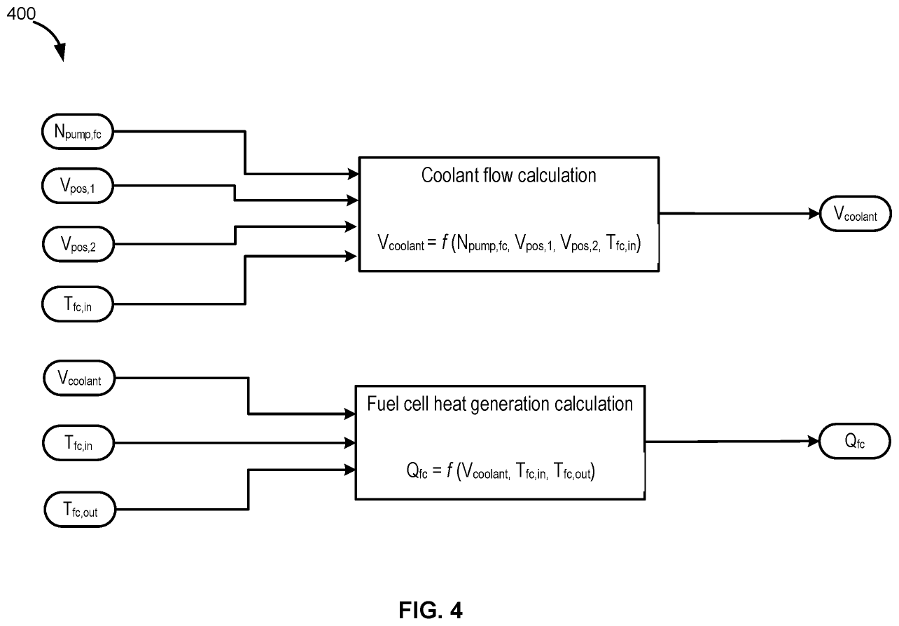

With reference now to FIG. 4, a block diagram of a control logic 400 for a thermal management system (e.g., integrated thermal management system 200) is illustrated, in accordance with various embodiments. Control logic 400 may implement a method (e.g., method 300 of FIG. 3) for managing thermal loads in an electric vehicle (e.g., an FCEV). More particularly, control logic 400 may be used for calculating a fuel cell coolant flow value and a fuel cell heat generation value. With combined additional reference to FIG. 1, FIG. 2, and FIG. 3, control logic 400 may receive a fuel cell coolant loop pump speed (e.g., N_{pump,fc}), a first valve position (e.g., V_{pos,1}), a second valve position (e.g., V_{pos,2}), a coolant temperature at an inlet of a fuel cell system (e.g., T_{fc,in}, which may be a temperature between 60° C. and 65° C. or another suitable temperature as desired), and a coolant temperature at an outlet of the fuel cell system (e.g., T_{fc,out}, which may be a temperature between 65° C. and 75° C. or another suitable temperature as desired). In various embodiments, receiving the above variables may comprise measuring the above variables using flow sensors, position sensors, temperature sensors, and/or the like. In various embodiments, the fuel cell coolant loop pump speed (N_{pump,fc}) may correspond to the speed of first pump 238, the first valve position (V_{pos,1}) may correspond to the valve position of first valve 214, the second valve position (V_{pos,2}) may correspond to the position of second valve 270, the coolant temperature at the inlet of the fuel cell system (T_{fc,in}) may correspond to the coolant temperature at the inlet of fuel cell system 210, and the coolant temperature at the outlet of the fuel cell system (T_{fc,out}) may correspond to the coolant temperature at the outlet of fuel cell system 210. In various embodiments, the coolant temperature at the inlet of the fuel cell system (T_{fc,in}) and the coolant temperature at the outlet of the fuel cell system (T_{fc,out}) may be determined using temperature sensors placed near the inlet and outlet of a fuel cell stack, for example. In various embodiments, the first valve position (V_{pos,1}) and the second valve position (V_{pos,2}) may be expressed as a percentage between 0% and 100%, where 0% correlates to a fully closed position and 100% correlates to a fully open position. More specifically, where the first valve position (V_{pos,1}) is fully open (100%), all of the fuel cell coolant may be directed to coolant-coolant heat exchanger 266. Where the second valve position (V_{pos,2}) is fully open (100%), all of the fuel cell coolant may be directed through bypass line 216 to bypass fuel cell radiator 230.

Control logic 400 may further be configured to calculate a fuel cell coolant flow value (e.g., V_{coolant}) using the pump speed (N_{pump,fc}), the first valve position (V_{pos,1}), the second valve position (V_{pos,2}), and the coolant temperature at the inlet of the fuel cell system (T_{fc,in}). In various embodiments, the fuel cell coolant flow value (V_{coolant}) may be calculated using a polynomial expression, a lookup table, or a combination thereof. Alternatively, in some exemplary embodiments, the fuel cell coolant flow value (V_{coolant}) may be based, in part, on the characteristics of fuel cell coolant loop 202 and/or heat exchanger loop 208, such as line cross-sectional area, measured fluid pressures, and/or fluid velocities in fuel cell coolant line 212 and/or heat exchanger line 268. In some exemplary embodiments, the fuel cell coolant flow value (V_{coolant}) may be calculated without considering the first valve position (V_{pos,1}) and/or second valve position (V_{pos,2}), for example, where those valves are fully closed, fully open, or absent from the system. As described in further detail below, the fuel cell coolant flow value (V_{coolant}) may be used as an input for additional control logic.

Control logic 400 may be further configured to calculate a fuel cell heat generation value (e.g., Q_{fc}). In various embodiments, the fuel cell heat generation value (Q_{fc}) may be calculated using the fuel cell coolant flow value (V_{coolant}), the coolant temperature at the inlet of the fuel cell system (T_{fc,in}), and the coolant temperature at the outlet of the fuel cell system (T_{fc,out}). In various embodiments, the fuel cell heat generation value (Q_{fc}) may be calculated using a polynomial expression, a lookup table, or a combination thereof. Alternatively, in some exemplary embodiments, the fuel cell heat generation value (Q_{fc}) may be based, in part, on the characteristics of fuel cell system 210, such as the power output over a given time. In some exemplary embodiments, the fuel cell heat generation value (Q_{fc}) may be based, in part, on measured temperatures near or around fuel cell system 210. In some exemplary embodiments, the fuel cell heat generation value (Q_{fc}) may be a maximum of multiple fuel cell heat generation values calculated based on multiple fuel cell stacks. As described in further detail below, the fuel cell heat generation value (Q_{fc}) may be used as an input for additional control logic.

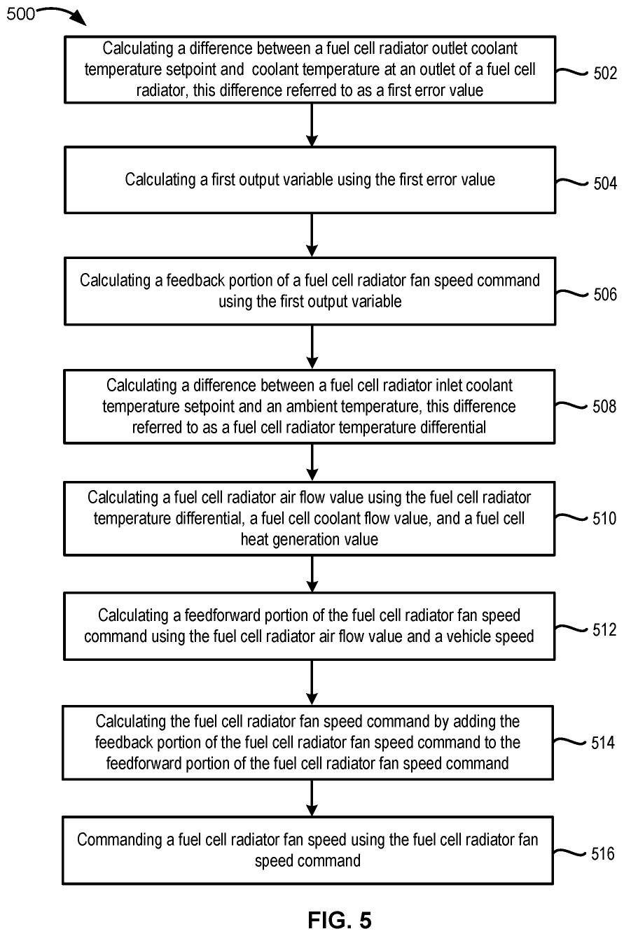

With reference now to FIG. 5, a flow chart illustrating a method 500 of managing thermal loads in an electric vehicle (e.g., an FCEV) is illustrated in accordance with various embodiments. Method 500 may comprise calculating a difference between a fuel cell radiator outlet coolant temperature setpoint and a coolant temperature at an outlet of a fuel cell radiator, this difference referred to as a first error value (step 502). Method 500 may further comprise calculating a first output variable using the first error value (step 504). Method 500 may further comprise calculating a feedback portion of a fuel cell radiator fan speed command using the first output variable (step 506). Method 500 may further comprise calculating a difference between a fuel cell radiator inlet coolant temperature setpoint and an ambient temperature, this difference being referred to as a fuel cell radiator temperature differential (step 508). Method 500 may further comprise calculating a fuel cell radiator air flow value using the fuel cell radiator temperature differential, a fuel cell coolant flow value, and a fuel cell heat generation value (step 510). Method 500 may further comprise calculating a feedforward portion of the fuel cell radiator fan speed command using the fuel cell radiator air flow value and a vehicle speed (step 512). Method 500 may further comprise calculating the fuel cell radiator fan speed command by adding the feedback portion of the fuel cell radiator fan speed command to the feedforward portion of the fuel cell radiator fan speed command (step 514). Method 500 may further comprise controlling/commanding fuel cell radiator fan speed using the fuel cell radiator fan speed command (step 516). In various embodiments, method 500 further comprises passing a heated coolant through the fuel cell radiator to cool the fuel cell coolant.

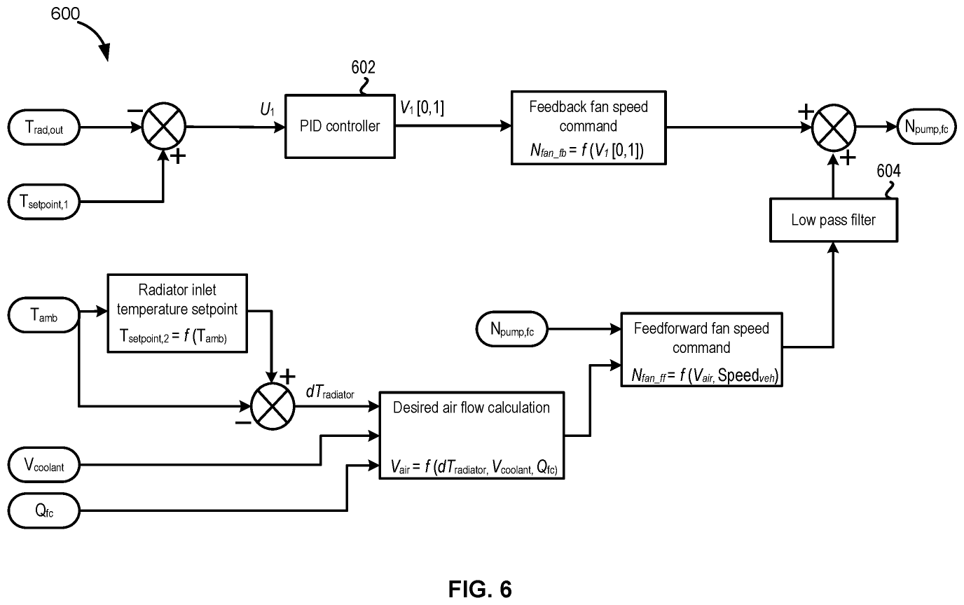

With reference now to FIG. 6, a block diagram of a control logic 600 for a thermal management system (e.g., integrated thermal management system 200) is illustrated, in accordance with various embodiments. Control logic 600 may implement a method for managing thermal loads in an electric vehicle (e.g., an FCEV). More specifically, and with combined additional reference to FIG. 1, FIG. 2, and FIG. 5, control logic 600 may be implemented for regulating fuel cell radiator fan speed (N_{fan,fc}). The fuel cell radiator fan speed (N_{fan,fc}) may be regulated using a combination of feedback control (proportional-integral-derivative—PID) and feedforward control. Feedforward control tends to account for disturbances using a process model before the disturbances affect the process. Feedback control tends to compensate for disturbances by providing corrective action after they affect the process. The combined feedback and feedforward control tends to ensure smooth performance of integrated thermal management system 200, particularly fuel cell radiator fan 232.

The feedback portion of the fan speed command may be regulated using a first PID controller 602 based on the feedback of the coolant temperature (e.g., T_{rad,out}, which may be a temperature between 60° C. and 65° C. or another suitable temperature as desired) at the outlet of fuel cell radiator 230. The difference between a fuel cell radiator outlet coolant temperature setpoint (e.g., T_{setpoint,1}, which may be a temperature between 60° C. and 65° C. or another suitable temperature as desired) and the measured temperature (e.g., T_{rad,out}) at the fuel cell radiator 230 outlet is used as a first error value (u₁) for the first PID controller 602. The first error value (u₁) may be minimized by the first PID controller 602 by adjusting and optimizing a first output variable (v₁) using proportional, integral, and/or derivative control actions. In various embodiments, the first output variable (v₁) may be a value between 0 and 1. The first output variable (v₁) is then used to compute the feedback portion of the fuel cell radiator fan speed command (N_{fan,fc}), for example using a polynomial expression, lookup table, or a combination thereof.

For the feedforward controller, a process model (e.g., a heat transfer model) may be used to correlate the effect of disturbances (e.g., first valve position, second valve position, pump speed) on the controlled variable (radiator fan speed). More specifically, the fuel cell coolant loop pump speed (N_{pump,fc}), the first valve position (V_{pos,1}), the second valve position (V_{pos,2}), and the coolant temperature at the inlet of the fuel cell system (T_{fc,in}) may be used to calculate the fuel cell coolant flow value (V_{coolant}) as previously described with respect to FIG. 4. Further, the fuel cell coolant flow value (V_{coolant}), the coolant temperature at the inlet of the fuel cell system (T_{fc,in}), and the coolant temperature at the outlet of the fuel cell system (T_{fc,out}) may be used to calculate the fuel cell heat generation value (Q_{fc}) as previously described with respect to FIG. 4. A fuel cell radiator inlet coolant temperature setpoint (T_{setpoint,2}) may be computed using a measured ambient temperature (T_{amb}), for example, using a polynomial expression, a lookup table, or a combination thereof. A fuel cell radiator temperature differential (dT_{radiator}) may be defined as the difference between the fuel cell radiator inlet coolant temperature setpoint (T_{setpoint,2}) and the measured ambient temperature (T_{amb}). Using the fuel cell heat generation value (Q_{fc}), the fuel cell coolant flow value (V_{coolant}), and the fuel cell radiator temperature differential (dT_{radiator}), the desired fuel cell radiator air flow value (Vₐᵢᵣ) may be computed, for example, using a 3D lookup table or an empirical radiator heat transfer model. The measured vehicle speed (Speedᵥₑₕ) can then be utilized along with the desired radiator air flow value (Vₐᵢᵣ) to calculate the feedforward portion of the fuel cell radiator fan speed command (N_{fan,ff}). A first order (or second order) low pass filter 604 (also referred to as a lag filter) may be applied to the feedforward portion (N_{fan,ff}) before it is added to the feedback portion (N_{fan,fb}) to obtain the final fuel cell radiator fan command (N_{fan,fc}). In this regard, control logic 600 may comprise sending the final fuel cell radiator fan command (N_{fan,fc}) to fuel cell radiator fan 232 to regulate the speed of fuel cell radiator fan 232, thereby regulating the fuel cell coolant temperature.

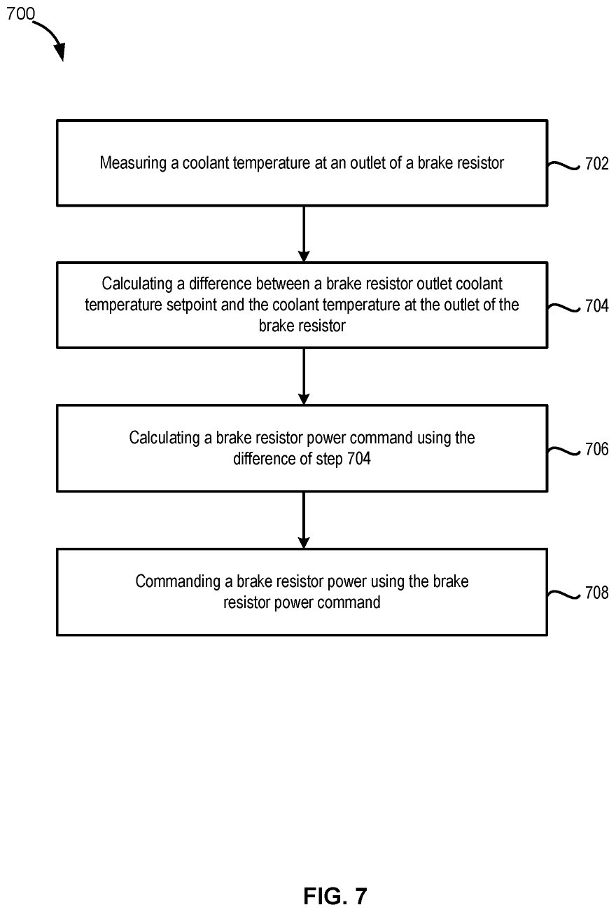

With reference now to FIG. 7, a flow chart illustrating a method 700 of managing thermal loads in an electric vehicle (e.g., an FCEV) is illustrated in accordance with various embodiments. Method 700 may comprise measuring a coolant temperature at an outlet of a brake resistor (step 702). Method 700 may further comprise calculating a difference between a brake resistor outlet coolant temperature setpoint and the coolant temperature at the outlet of a brake resistor (step 704). Method 700 may further comprise calculating a brake resistor power command using the difference of step 704 (step 706). Method 700 may further comprise controlling/commanding a brake resistor power using the brake resistor power command (step 708). In various embodiments, method 700 may further comprise increasing an electric current to the brake resistor. In various embodiments, method 700 further comprises passing a brake resistor coolant through the brake resistor to form a heated brake resistor coolant. In various embodiments, method 700 further comprises passing the heated brake resistor coolant through the brake resistor radiator to cool the heated brake resistor coolant.

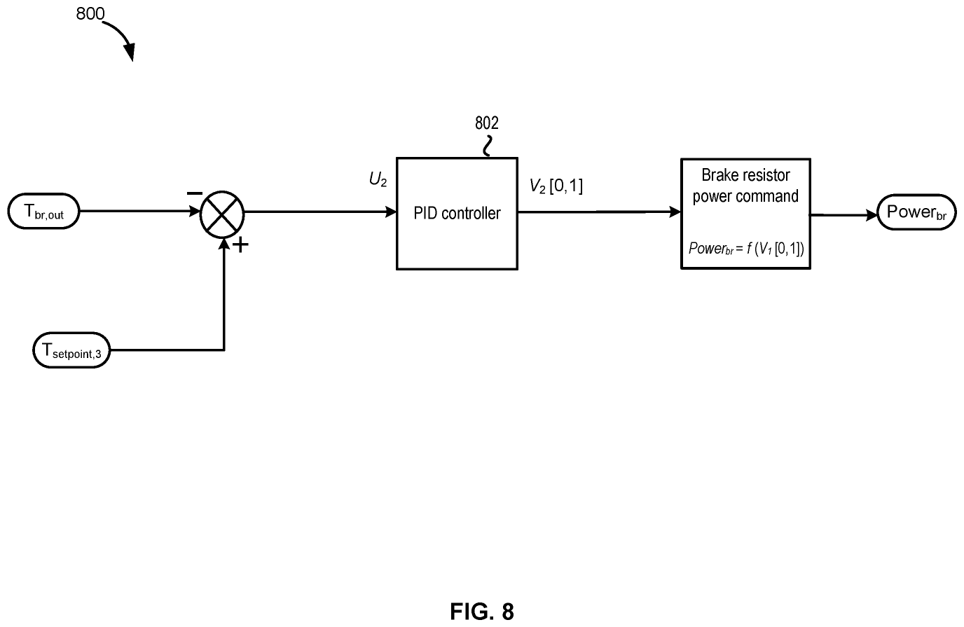

With reference now to FIG. 8, a block diagram of a control logic 800 for a thermal management system (e.g., integrated thermal management system 200) is illustrated, in accordance with various embodiments. Control logic 800 may implement a method for managing thermal loads in an electric vehicle (e.g., an FCEV). More specifically, and with combined additional reference to FIG. 1, FIG. 2, and FIG. 7, control logic 800 may be implemented for controlling/commanding a brake resistor power (e.g., Power_{br}). Control logic 800 may comprise measuring a coolant temperature at an outlet of a brake resistor (e.g., T_{br,out}, which may be a temperature between 50° C. and 95° C. or another suitable temperature as desired). In various embodiments, the coolant temperature at the outlet of the brake resistor (T_{br,out}) may correspond to the brake resistor coolant temperature at the outlet of brake resistor 240. In some exemplary embodiments, control logic 800 may comprise receiving a coolant temperature at an outlet of a brake resistor instead of, or in addition to, measuring a coolant temperature at an outlet of a brake resistor. Control logic 800 may further be configured to calculate a difference between a brake resistor outlet coolant temperature setpoint (e.g., T_{setpoint,3}, which may be a temperature between 90° C. and 95° C. or another temperature capable of avoiding outlet coolant overheating and/or boil-off) and the coolant temperature at the outlet of the brake resistor (T_{br,out}). Using the difference between the brake resistor outlet coolant temperature setpoint (T_{setpoint,3}) and the coolant temperature at the outlet of the brake resistor (T_{br,out}), a second error value (u₂) may be obtained. The second error value (u₂) may be minimized by a PID controller 802 (which may be the same controller as or a different controller from PID controller 602) by adjusting and optimizing a second output variable (v₂) using proportional, integral, and/or derivative control actions. The second output variable (v₂) may be a value between 0 and 1. The second output variable (v₂) may then be used to compute a brake resistor power command (Power_{br}), for example using a polynomial expression, lookup table, or a combination thereof. Brake resistor 240 may then be commanded to dissipate a desired amount of electric power based on the brake resistor power command. More specifically, control logic 800 may further be configured to regulate the amount of current delivered to brake resistor 240, for example, from a high voltage bus, fuel cell system 210, a high voltage battery system, and/or one or more electric motors (through regenerative braking). In response, brake resistor 240 may generate and transfer heat to the brake resistor coolant loop coolant.

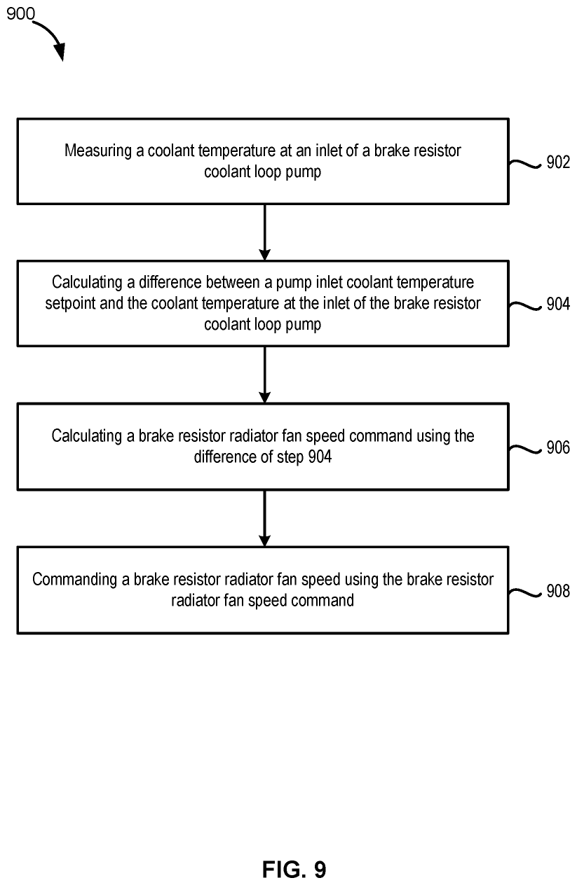

With reference now to FIG. 9, a flow chart illustrating a method 900 of managing thermal loads in an electric vehicle (e.g., an FCEV) is illustrated in accordance with various embodiments. Method 900 may comprise measuring a coolant temperature at an inlet of a brake resistor coolant loop pump (step 902). Method 900 may further comprise calculating a difference between a pump inlet coolant temperature setpoint and the coolant temperature at the inlet of the brake resistor coolant loop pump (step 904). Method 900 may further comprise calculating a brake resistor radiator fan speed command using the difference of step 904 (step 906). Method 900 may further comprise controlling/commanding a brake resistor radiator fan speed using the brake resistor radiator fan speed command (step 908). In various embodiments, method 900 further comprises passing a brake resistor coolant through a brake resistor to form a heated brake resistor coolant. In various embodiments, method 900 further comprises passing the heated brake resistor coolant through the brake resistor radiator to cool the heated brake resistor coolant.

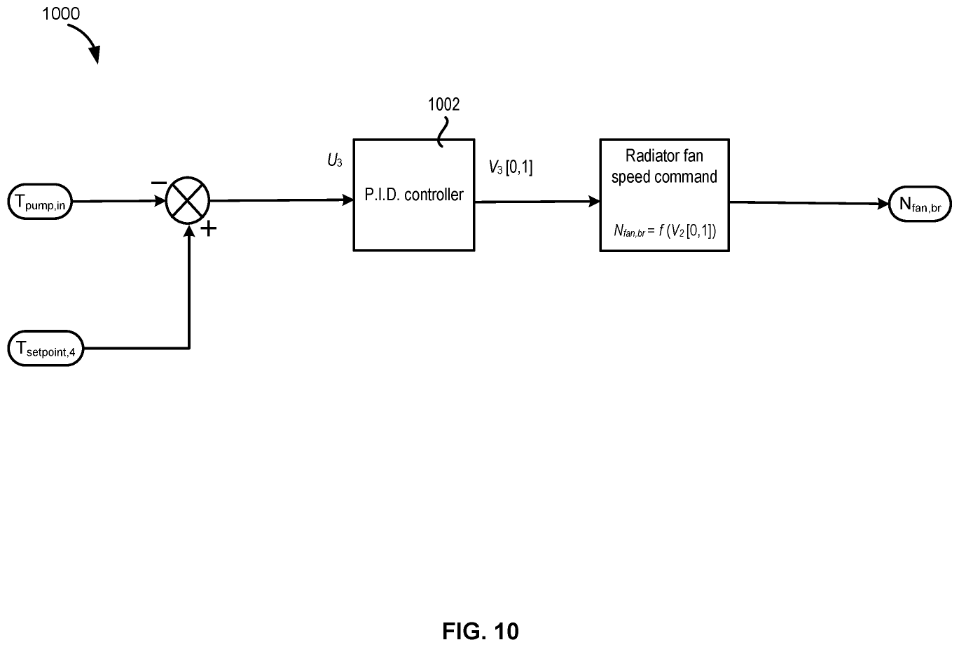

With reference now to FIG. 10, a block diagram of a control logic 1000 for a thermal management system (e.g., integrated thermal management system 200) is illustrated, in accordance with various embodiments. Control logic 1000 may implement a method for managing thermal loads in an electric vehicle (e.g., an FCEV). More specifically, and with combined additional reference to FIG. 1, FIG. 2, and FIG. 9, control logic 1000 may be implemented for controlling/commanding brake resistor radiator fan speed (e.g., N_{fan,br}). Control logic 1000 may comprise measuring a coolant temperature at an inlet of a brake resistor coolant loop pump (e.g., T_{pump,in}, which may be a temperature between 50° C. and 75° C. or another suitable temperature as desired). In various embodiments, the coolant temperature at the inlet of the brake resistor coolant loop pump (T_{pump,in}) may correspond to the brake resistor coolant temperature at the inlet of pump 264. In some exemplary embodiments, control logic 1000 may comprise receiving a coolant temperature at an outlet of a brake resistor instead of or in addition to measuring a coolant temperature at an outlet of a brake resistor. Control logic 1000 may further be configured to calculate a difference between a pump inlet coolant temperature setpoint (e.g., T_{setpoint,4}, which may be a temperature between 70° C. and 75° C. or another temperature capable of ensuring coolant inlet temperature requirements of the brake resistor are met) and the coolant temperature at the inlet of the brake resistor coolant loop pump (T_{pump,in}). Using the difference between the pump inlet coolant temperature setpoint (T_{setpoint,4}) and the coolant temperature at the inlet of the brake resistor coolant loop pump (T_{pump,in}), a third error value (u₃) may be obtained. The third error value (u₃) may be minimized by a PID controller 1002 (which may be the same controller as or a different controller from PID controllers 602, 802) by adjusting and optimizing a third output variable (v₃) using proportional, integral, and/or derivative control actions. In various embodiments, the third error value (u₃) may be calculated using a lookup table. The third output variable (v₃) may be a value between 0 and 1. The third output variable (v₃) may then be used to compute a brake resistor radiator fan speed command (N_{fan,br}), for example using a polynomial expression, lookup table, or a combination thereof. Brake resistor radiator fan 260 may then be commanded to the desired speed utilizing the brake resistor radiator fan speed command (N_{fan,br}).

In addition to the methods and control logic for controlling/commanding fuel cell radiator fan speed, brake resistor power, and/or brake resistor radiator fan speed, various embodiments described herein may further include methods and control logic for controlling/commanding other component functions of vehicle 100. For example, in various embodiments, the methods described above may further include controlling/commanding a brake resistor coolant loop pump speed (e.g., N_{pump,br}). The brake resistor coolant pump speed (N_{pump,br}) may be a fixed percentage, where 0% correlates to a minimum speed (or no speed) and 100% correlates to a maximum speed.

The thermal management systems, methods, and logic described herein may result in numerous benefits. More particularly, the feedback portion of the fuel cell radiator fan speed command helps to ensure smooth fan operation by avoiding speed fluctuations while maintaining the desired fuel cell coolant temperature at the outlet of the fuel cell radiator. More particularly, the feedback portion of the fuel cell radiator fan speed command may be used to “trim” the feedforward portion of the fuel cell radiator fan speed command due to lack of measurement resolution and potential inaccuracies of the feedforward portion. The feedforward portion of the fuel cell radiator fan speed command helps to avoid overheating of the fuel cell system by ensuring adequate precooling of the system, in part, by rejecting measurable disturbances from the desired outlet coolant temperature setpoint. Further, the feedforward portion of the fuel cell radiator fan speed command helps to ensure that the fuel cell radiator fan reacts (or speeds up) fast enough during high load use cases for vehicle 100 (which tend to lead to the fuel cell system generating more heat), rather than waiting for the feedback portion of the coolant temperature at the fuel cell radiator outlet to increase sufficiently. Further, the brake resistor power control logic/methods described herein may reduce temperature fluctuations at the inlet of the brake resistor, thereby enabling more consistent power dissipation and efficient thermal operation. Still further, the brake resistor fan speed control logic/methods described herein may reduce fluctuations in fan speed and thus optimize fan power consumption.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” or “at least one of A, B, and C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Methods, systems, and articles are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method of managing thermal loads in a fuel cell electric vehicle, the method comprising:
measuring a coolant temperature at an outlet of a fuel cell radiator;
calculating, by a microprocessor onboard the fuel cell electric vehicle, a fuel cell coolant flow value;
calculating, by the microprocessor, a fuel cell heat generation value;
calculating, by the microprocessor, a feedback portion of a fuel cell radiator fan speed command using the coolant temperature at the outlet of the fuel cell radiator;
calculating, by the microprocessor, a feedforward portion of the fuel cell radiator fan speed command using an ambient temperature, the fuel cell coolant flow value, and the fuel cell heat generation value;
calculating, by the microprocessor, the fuel cell radiator fan speed command using the feedforward portion and the feedback portion; and
controlling a fuel cell radiator fan speed using the fuel cell radiator fan speed command.

2. The method of claim 1, wherein the fuel cell coolant flow value is calculated using a pump speed, a first valve position, a second valve position, and a coolant temperature at an outlet of a fuel cell system.

3. The method of claim 1, wherein the fuel cell heat generation value is calculated using the fuel cell coolant flow value, a coolant temperature at an inlet of a fuel cell system, and a coolant temperature at an outlet of the fuel cell system.

4. The method of claim 1, further comprising calculating, by the microprocessor, a first error value based on a difference between a fuel cell radiator outlet coolant temperature setpoint and the coolant temperature at the outlet of the fuel cell radiator.

5. The method of claim 4, further comprising performing a proportional-integral-derivative (PID) control action using the first error value to determine a first output variable.

6. The method of claim 1, further comprising calculating, by the microprocessor, a fuel cell radiator temperature differential by calculating a difference between a fuel cell radiator inlet coolant temperature setpoint and the ambient temperature.

7. The method of claim 6, further comprising calculating, by the microprocessor, a fuel cell air flow value using the fuel cell radiator temperature differential, the fuel cell coolant flow value, and the fuel cell heat generation value.

8. The method of claim 7, wherein the feedforward portion of the fuel cell radiator fan speed command is calculated using the fuel cell air flow value and a vehicle speed.

9. The method of claim 1, further comprising filtering the feedforward portion of the fuel cell radiator fan speed command using a low pass filter.

10. The method of claim 1, wherein calculating the fuel cell radiator fan speed command comprises adding the feedforward portion and the feedback portion.

11. The method of claim 2, wherein the first valve position corresponds to a valve position of a first valve upstream of a coolant-coolant heat exchanger.

12. A method of managing thermal loads in a fuel cell electric vehicle, the method comprising:
calculating a fuel cell radiator fan speed command using a first coolant temperature;
calculating a brake resistor power command using a second coolant temperature;
calculating a brake resistor radiator fan speed command using a third coolant temperature;
controlling a fuel cell radiator fan speed using the fuel cell radiator fan speed command;
controlling a brake resistor power using the brake resistor power command; and
controlling a brake resistor radiator fan speed using the brake resistor radiator fan speed command.

13. The method of claim 12, wherein the first coolant temperature is associated with a first coolant and the second coolant temperature and the third coolant temperature are associated with a second coolant.

14. The method of claim 12, wherein the first coolant temperature is measured at an outlet of a fuel cell radiator, the second coolant temperature is measured at an outlet of a brake resistor, and the third coolant temperature is measured at a pump inlet.

15. The method of claim 12, wherein a proportional-integral-derivative (PID) control action is used to calculate each of the fuel cell radiator fan speed command, the brake resistor power command, and the brake resistor radiator fan speed command.

16. The method of claim 12, wherein calculating the fuel cell radiator fan speed command comprises calculating a fuel cell coolant flow value and a fuel cell heat generation value.

17. A method of managing thermal loads in a fuel cell electric vehicle, the method comprising:
measuring a first coolant temperature at an outlet of a brake resistor;
calculating a first difference between a brake resistor outlet coolant temperature setpoint and the first coolant temperature;
calculating a brake resistor power command using the first difference;
measuring a second coolant temperature at an inlet of a pump;
calculating a second difference between a pump inlet temperature setpoint and the second coolant temperature;
calculating a brake resistor radiator fan speed command using the second difference;
controlling a brake resistor power using the brake resistor power command; and
controlling a brake resistor radiator fan speed using the brake resistor radiator fan speed command.

18. The method of claim 17, wherein the first difference is used as a first error value for a first proportional-integral-derivative (PID) control action.

19. The method of claim 18, wherein the second difference is used as a second error value for a second PID control action.

20. The method of claim 18, wherein the first PID control action outputs a first output variable that is used to calculate the brake resistor power command.
